(19) United States
(12) Patent Application Publication
(10) Pub. No.: US 2015/0031592 A1
(43) Pub. Date: Jan. 29, 2015

(54) MICROFIBRILLAR CELLULOSE AS DIRT-REMOVING ACTIVE SUBSTANCE

(71) Applicant: Henkel AG & Co. KGaA, Duesseldorf (DE)

(72) Inventors: Paula Barreleiro, Ginsheim-Gustavsburg (DE); Kerstin Ziganke, Hilden (DE); Benoit Luneau, Ratingen (DE)

(21) Appl. No.: 14/511,846

(22) Filed: Oct. 10, 2014

Related U.S. Application Data
(63) Continuation of application No. PCT/EP2013/057156, filed on Apr. 5, 2013.

(30) Foreign Application Priority Data
Apr. 12, 2012 (DE) 10 2012 206 014.6

(51) Int. Cl. C11D 3/22; C11D 3/00

(52) U.S. Cl. CPC C11D 3/222; C11D 3/001
USPC 510/344; 510/463; 510/515

(57) ABSTRACT

The cleaning performance of detergents and cleansers when washing textiles or cleaning hard surfaces was to be improved. This was successful substantially due to the use of microfibrillar cellulose.

### FIELD OF THE INVENTION

The present invention generally relates to the use of specific soil release promoting active agents for enhancing the cleaning performance of washing agents in the washing of textiles and the cleaning of hard surfaces, to washing and cleaning agents that contain these soil release promoting active agents and to the use of these soil release promoting active agents to form a protective layer on hard surfaces and on textile fabrics.

### BACKGROUND OF THE INVENTION

In addition to the ingredients that are essential for the washing process, such as surfactants and builder materials, washing agents generally contain other constituents that can be grouped together under the term washing auxiliaries, which comprise different groups of active agents such as foam regulators, anti-grays, bleaching agents, bleach activators and dye transfer inhibitors. These auxiliaries also include substances that provide the laundry fibers with soil-repellent properties and, if present during the wash cycle, support the soil release capacity of the other washing agent constituents. The same also applies mutatis mutandis to cleaning agents for hard surfaces. These soil release promoting substances are often referred to as “soil-release” active agents or, because of their ability to provide the treated surface, for example of the fiber, with soil-repellent properties, as “soil repellents”. For instance, the soil release promoting action of methylcellulose is known e.g. from U.S. Pat. No. 4,136,038. European patent application EP 0 213 729 discloses reduced redeposition with the use of washing agents containing a combination of soap and nonionic surfactant with alkyl hydroxyalkyl cellulose. From European patent application EP 0 213 730, textile treatment agents are known which contain cationic surfactants and nonionic cellulose ethers having HLB values of 3.1 to 3.8. U.S. Pat. No. 4,000,093 discloses washing agents that contain 0.1 wt. % to 3 wt. % alkyl cellulose, hydroxyalkyl cellulose or alkyl hydroxyalkyl cellulose as well as 5 wt. % to 50 wt. % surfactant, wherein the surfactant component substantially consists of C₁₀ to C₁₃ alkyl sulfate and up to 5 wt. % C₁₄ alkyl sulfate and less than 5 wt. % alkyl sulfate with alkyl residues of C₁₅ and higher.

Owing to their chemical similarity to polyester fibers, particularly effective soil release promoting active agents in textiles made of this material are copolyesters containing dicarboxylic acid units, such as terephthalic acid or sulfoisophthalic acid, alkylene glycol units, such as ethylene glycol or propylene glycol, and polyalkylene glycol units, such as polyethylene glycol. Soil release promoting copolyesters of the said type as well as their use in washing agents have been known for a long time.

The polymers that are known from the prior art have the disadvantage that they have insufficient or no activity in particular for textiles that do not, or at least do not predominantly, consist of polyester. However, a large proportion of textiles today consist of cotton or polyester-cotton blended fabrics, and so a need exists for more effective soil release promoting active agents for greasy soils, in particular on textiles of this type.

Surprisingly, it has been found that this object can be achieved by the use of specific celluloses. In addition, these celluloses also exhibit a corresponding enhancement of cleaning in the cleaning of hard surfaces.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Use of microfibrillar cellulose to enhance the cleaning performance of washing agents during the washing of textiles and of cleaning agents during the cleaning of hard surfaces.

Use of microfibrillar cellulose to form a protective layer on hard surfaces and on textile fabrics.

A method of washing textiles or cleaning hard surfaces, in which a washing or cleaning agent and a microfibrillar cellulose are employed.

A washing or cleaning agent containing microfibrillar cellulose.

A laundry post-treatment agent, in particular a softener, containing microfibrillar cellulose.

In some embodiments, the washing, cleaning, or post-treatment agent can comprise microfibrillar cellulose in quantities of 0.01 wt. % to 10 wt. %, in particular of 0.05 wt. % to 4 wt. %.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention provides the use of microfibrillar cellulose to enhance the cleaning performance of washing agents in the washing of textiles and of cleaning agents in the cleaning of hard surfaces.

The invention also provides the use of microfibrillar cellulose to form a protective layer on hard surfaces and on textile fabrics.

Microfibrillar celluloses here are to be understood as celluloses in the form of microfibrils. Cellulose fibers consist of macrofibrils, which in turn consist of a plurality of microfibrils. The microfibrils have a diameter of preferably 20 nm to 600 nm, in particular 100 nm to 200 nm and in a preferred embodiment a number average length of 50 μm to 500 μm, in particular 80 μm to 200 μm, and in another preferred embodiment a length of 1 μm to 20 μm, in particular 3 μm to 5 μm. Microfibrillar cellulose is commercially available e.g. with the trade name Vitacel®.

The invention also provides a method of washing textiles or cleaning hard surfaces, in which a washing or cleaning agent and a soil release promoting active agent in the form of microfibrillar cellulose are employed. These methods can be performed manually or optionally with the aid of a conventional domestic washing machine or an automatic dishwashing machine. It is possible to use the, in particular, bleaching agent-containing washing or cleaning agent and the soil release promoting active agent simultaneously or consecutively. The simultaneous use can be carried out particularly advantageously by employing a washing or cleaning agent that contains the soil release promoting active agent.

The effect of the active agent to be used according to the invention is particularly marked in the case of multiple use, i.e. in particular to remove soils from hard surfaces or textiles that have already been cleaned or washed and/or post-treated in the presence of the active agent before being provided with the soil. In connection with post-treatment, it should be pointed out that the positive aspect referred to can also be achieved by a washing process in which, after the actual wash cycle, which is performed with the aid of a washing agent that can contain a said active agent but in this case can also be free from this, the textile is brought into contact with a post-treatment agent, e.g. in the context of a fabric softening step, which post-treatment agent contains an active agent to be used according to the invention. With this procedure too, even if again, during the next wash cycle, a washing agent without an active agent to be used according to the invention is used if desired, the wash performance enhancing effect of the active agents to be used according to the inventions occurs. This effect is significantly greater than one obtained with the use of a conventional SRP active agent. In a particularly preferred embodiment, the addition of the active agent that is essential to the invention takes place here in the fabric-softening cycle of the textile wash.

The active agent used according to the invention leads to a significantly better removal of, in particular, grease and cosmetic soils on textiles, in particular those made of cotton or cotton-containing fabric, than is the case with the use of compounds previously known for this purpose. Alternatively, with the same grease-removing power, significant quantities of surfactants can be saved.

The use according to the invention can take place in the context of a washing or cleaning process by adding the soil release promoting active agent to a liquor that contains washing or cleaning agent or preferably by introducing the active agent into the liquor which contains the object to be cleaned, or which is brought into contact therewith, as a constituent of a washing or cleaning agent. The invention therefore also provides washing or cleaning agents containing microfibrillar cellulose.

The use according to the invention in the context of a laundry post-treatment process can similarly take place by adding the soil release promoting active agent separately to the rinsing liquor that is used after the wash cycle that has taken place using, in particular, a bleaching agent-containing washing agent, or introducing it as a constituent of the laundry post-treatment agent, in particular a softener. The invention therefore also provides a laundry post-treatment agent, in particular a softener, containing microfibrillar cellulose. In this aspect of the invention, the washing agent used before the laundry post-treatment agent can likewise contain an active agent to be used according to the invention, but can also be free from this.

The washing or cleaning cycle preferably takes place at a temperature of 15° C. to 60° C., particularly preferably at a temperature of 20° C. to 40° C. The washing or cleaning cycle furthermore preferably takes place at a pH value of 6 to 11, particularly preferably at a pH value of 7.5 to 9.5.

Agents that contain an active agent to be used according to the invention in the form of microfibrillar cellulose or that are used together with this or are employed in methods according to the invention, can contain any other conventional constituents of these agents that do not interact in an undesirable manner with the active agent, in particular surfactant, that is essential to the invention. The above-defined active agent is employed preferably in quantities of 0.01 wt. % to 10 wt. %, particularly preferably of 0.05 wt. % to 4 wt. % and in particular of 0.2 wt. % to 1 wt. %, these and the following quantitative data being based on the total agent, unless otherwise indicated.

Surprisingly, it has been found that the active agent used according to the invention has a positive effect on the action of certain other washing and cleaning agent ingredients and that, conversely, the action of the soil-release active agent is additionally enhanced by certain other washing agent ingredients. These effects occur in particular with bleaching agents, enzymatic active agents, in particular proteases and lipases, water-soluble inorganic and/or organic builders, in particular based on oxidized carbohydrates or polymeric polycarboxylates, synthetic anionic surfactants of the sulfate and sulfonate type, and dye transfer inhibitors, e.g. vinylpyrrolidone, vinylpyridine or vinylimidazole polymers or copolymers or corresponding polybetaines, and therefore the use of at least one of said other ingredients together with active agent to be used according to the invention is preferred.

An agent that contains an active agent to be used according to the invention or that is used together with this, or is employed in the method according to the invention, preferably contains bleaching agent based on peroxygen, in particular in quantities in the range from 5 wt. % to 70 wt. %, and optionally bleach activator, in particular in quantities in the range from 2 wt. % to 10 wt. %, but in another preferred embodiment it can also be free from bleaching agent and bleach activator. The bleaching agents that are suitable are preferably the peroxygen compounds that are generally used in washing agents, such as peroxycarboxylic acids, e.g. diperoxydodecanoic acid or phthaloylaminoperoxycaproic acid, hydrogen peroxide, alkali perborate, which can be present as a tetrahydrate or monohydrate, percarbonate, perpyrophosphate and persilicate, which are generally present as alkali salts, in particular as sodium salts. These bleaching agents are contained in washing agents that contain an active agent used according to the invention preferably in quantities of up to 25 wt. %, in particular up to 15 wt. % and particularly preferably of 5 wt. % to 15 wt. %, based in each case on the total agent, with percarbonate being used in particular. The optionally present component of bleach activators comprises the conventionally used N- or O-acyl compounds, e.g. polyacylated alkylenediamines, in particular tetraacetyl ethylenediamine, acylated glycolurils, in particular tetraacetyl glycoluril, N-acylated hydantoins, hydrazides, triazoles, urazoles, diketopiperazines, sulfuryl amides and cyanurates, as well as carboxylic anhydrides, in particular phthalic anhydride, carboxylic acid esters, in particular sodium isononanoyl phenolsulfonate, and acylated sugar derivatives, in particular pentaacetyl glucose, as well as cationic nitrile derivatives, such as trimethylammonium acetonitrile salts. The bleach activators can have been coated with shell substances or granulated in a known manner to avoid interaction with the per compounds during storage, with particular preference being given to tetraacetyl ethylenediamine granulated with the aid of carboxymethyl cellulose having weight average particle sizes of 0.01 mm to 0.8 mm, granulated 1,5-diacetyl-2,4-dioxohexahydro-1,3,5-triazine and/or trialkylammonium acetonitrile formulated in particle form. These bleach activators are preferably contained in washing agents in quantities of up to 8 wt. %, in particular of 2 wt. % to 6 wt. %, based in each case on total agent.

In a preferred embodiment, an agent according to the invention, or which is used according to the invention or used in the method according to the invention, contains nonionic surfactant selected from fatty alkyl polyglycosides, fatty alkyl polyalkoxylates, in particular ethoxylates and/or propoxylates, fatty acid polyhydroxyamides and/or ethoxylation and/or propoxylation products of fatty alkylamines, vicinal diols, fatty acid alkyl esters and/or fatty acid amides and mixtures thereof, in particular in a quantity in the range from 2 wt. % to 25 wt. %.

Another embodiment of these agents comprises the presence of synthetic anionic surfactant of the sulfate and/or sulfonate type, in particular fatty alkyl sulfate, fatty alkyl ether sulfate, sulfo fatty acid ester and/or sulfo fatty acid disalts, in particular in a quantity in the range from 2 wt. % to 25 wt. %. The anionic surfactant is preferably selected from the alkyl or alkenyl sulfates and/or the alkyl or alkenyl ether sulfates, in which the alkyl or alkenyl group possesses 8 to 22, in particular 12 to 18, C atoms. These are usually not individual substances, but blends or mixtures. Among them, preference is given to those in which the proportion of compounds with relatively long-chain residues in the range from 16 to 18 C atoms is over 20 wt. %.

The suitable nonionic surfactants include the alkoxylates, in particular the ethoxylates and/or propoxylates, of saturated or mono- to polyunsaturated linear or branched-chain alcohols with 10 to 22 C atoms, preferably 12 to 18 C atoms. The degree of alkoxylation of the alcohols here is generally between 1 and 20, preferably between 3 and 10. They can be produced in a known manner by reacting the corresponding alcohols with the corresponding alkylene oxides. In particular, the derivatives of fatty alcohols are suitable, although their branched-chain isomers, in particular so-called oxo alcohols, can also be employed to produce alkoxylates that can be used. Accordingly, the alkoxylates, in particular the ethoxylates, of primary alcohols with linear, in particular dodecyl, tetradecyl, hexadecyl or octadecyl residues and mixtures thereof can be used. In addition, corresponding alkoxylation products of alkylamines, vicinal diols and carboxylic amides, which correspond to the said alcohols in terms of the alkyl part, can be used. Moreover, the ethylene oxide and/or propylene oxide insertion products of fatty acid alkyl esters and fatty acid polyhydroxyamides are also suitable. So-called alkyl polyglycosides that are suitable for incorporating into the agents according to the invention are compounds of the general formula (G)ₙ-OR¹², in which R¹² denotes an alkyl or alkenyl residue with 8 to 22 C atoms, G denotes a glycose unit and n denotes a number between 1 and 10. The glycoside component (G)ₙ represents oligomers or polymers comprising naturally occurring aldose or ketose monomers, which include in particular glucose, mannose, fructose, galactose, talose, gulose, altrose, allose, idose, ribose, arabinose, xylose and lyxose. The oligomers consisting of these glycosidically linked monomers are characterized not just by the nature of the sugars contained therein but by the number thereof, the so-called degree of oligomerization. The degree of oligomerization n, as an analytically determined parameter, generally assumes fractional numerical values; its value is between 1 and 10, and in the preferably employed glycosides it is below 1.5, in particular between 1.2 and 1.4. A preferred monomer building block, owing to its good availability, is glucose. The alkyl or alkenyl part R¹² of the glycosides preferably also comes from readily accessible derivatives of sustainable raw materials, in particular from fatty alcohols, although their branched-chain isomers, in particular so-called oxo alcohols, can be employed for the production of glycosides that can be used. It is accordingly also possible to use, in particular, primary alcohols with linear octyl, decyl, dodecyl, tetradecyl, hexadecyl or octadecyl residues and mixtures thereof. Particularly preferred alkyl glycosides contain a coconut fatty alkyl residue, i.e. mixtures with substantially R¹²=dodecyl and R¹²=tetradecyl.

Nonionic surfactant is contained in agents that contain a soil-release active agent used according to the invention, or that are used according to the invention or are employed in the method according to the invention, preferably in quantities of 1 wt. % to 30 wt. %, in particular of 1 wt. % to 25 wt. %, wherein quantities in the upper part of this range are more likely to be found in liquid washing agents and particulate washing agents are preferably more likely to contain smaller quantities of up to 5 wt. %.

The agents can, instead or in addition, contain further surfactants, preferably synthetic anionic surfactants of the sulfate or sulfonate type, such as e.g. alkylbenzenesulfonates, in quantities of preferably no more than 20 wt. %, in particular of 0.1 wt. % to 18 wt. %, based in each case on total agent. The alkyl and/or alkenyl sulfates with 8 to 22 C atoms that carry an alkali, ammonium or alkyl- or hydroxyalkyl-substituted ammonium ion as counter-cation should be mentioned as synthetic anionic surfactants that are particularly suitable for use in these agents. Preferred are the derivatives of fatty alcohols with, in particular, 12 to 18 C atoms and their branched-chain analogs, the so-called oxo alcohols. The alkyl and alkenyl sulfates can be produced in a known manner by reaction of the corresponding alcohol component with a conventional sulfation reagent, in particular sulfur trioxide or chlorosulfonic acid, and subsequent neutralization with alkali, ammonium or alkyl- or hydroxyalkyl-substituted ammonium bases. The surfactants of the sulfate type that can be employed also include the sulfated alkoxylation products of the said alcohols, so-called ether sulfates. These ether sulfates preferably contain 2 to 30, in particular 4 to 10, ethylene glycol groups per molecule. The suitable anionic surfactants of the sulfonate type include the α-sulfo esters obtainable by reaction of fatty acid esters with sulfur trioxide and subsequent neutralization, in particular the sulfonation products derived from fatty acids with 8 to 22 C atoms, preferably 12 to 18 C atoms, and linear alcohols with 1 to 6 C atoms, preferably 1 to 4 C atoms, and the sulfo fatty acids obtained therefrom by formal saponification.

Soaps may be considered as further optional surfactant ingredients, with saturated fatty acid soaps, such as the salts of lauric acid, myristic acid, palmitic acid or stearic acid, and soaps derived from natural fatty acid mixtures, for example coconut, palm kernel or tallow fatty acids, being suitable. In particular, those soap mixtures are preferred which are composed of 50 wt. % to 100 wt. % saturated C₁₂-C₁₈ fatty acid soaps and up to 50 wt. % oleic acid soap. Soap is preferably contained in quantities of 0.1 wt. % to 5 wt. %. In particular in liquid agents that contain a polymer used according to the invention, however, greater quantities of soap of generally up to 20 wt. % can be contained.

If desired, the agents can also contain betaines and/or cationic surfactants, which—if present—are preferably employed in quantities of 0.5 wt. % to 7 wt. %. Among these, the esterquats discussed below are particularly preferred.

In a further embodiment, the agent contains water-soluble and/or water-insoluble builders, in particular selected from alkali aluminosilicate, crystalline alkali silicate with a modulus greater than 1, monomeric polycarboxylate, polymeric polycarboxylate and mixtures thereof, in particular in quantities in the range from 2.5 wt. % to 60 wt. %.

The agent preferably contains 20 wt. % to 55 wt. % water-soluble and/or water-insoluble, organic and/or inorganic builder. The water-soluble organic builder substances include in particular those from the class of the polycarboxylic acids, in particular citric acid and sugar acids, as well as the polymeric (poly)carboxylic acids, in particular the polycarboxylates obtainable by oxidation of polysaccharides, polymeric acrylic acids, methacrylic acids, maleic acids and copolymers thereof, which can also contain small proportions of polymerizable substances without carboxylic acid functionality polymerized in. The relative molecular mass of the homopolymers of unsaturated carboxylic acids is generally between 5000 g/mol and 200000 g/mol, and that of the copolymers between 2000 g/mol and 200000 g/mol, preferably 50000 g/mol to 120000 g/mol, based on free acid. A particularly preferred acrylic acid-maleic acid copolymer has a relative molecular mass of 50000 g/mol to 100000 g/mol. Suitable, although less preferred, compounds of this class are copolymers of acrylic acid or methacrylic acid with vinyl ethers, such as vinyl methyl ethers, vinyl ester, ethylene, propylene and styrene, in which the proportion of the acid is at least 50 wt. %. It is also possible to employ terpolymers containing as monomers two carboxylic acids and/or salts thereof and, as a third monomer, vinyl alcohol and/or a vinyl alcohol derivative or a carbohydrate as water-soluble organic builder substances. The first acidic monomer or salt thereof is derived from a monoethylenically unsaturated C₃-C₈ carboxylic acid and preferably from a C₃-C₄ monocarboxylic acid, in particular from (meth)acrylic acid. The second acidic monomer or salt thereof can be a derivative of a C₄-C₈ dicarboxylic acid, with maleic acid being particularly preferred. The third monomeric unit in this case is formed by vinyl alcohol and/or preferably an esterified vinyl alcohol. In particular, vinyl alcohol derivatives are preferred which represent an ester of short-chain carboxylic acids, e.g. of C₁-C₄ carboxylic acids, with vinyl alcohol. Preferred terpolymers here contain 60 wt. % to 95 wt. %, in particular 70 wt. % to 90 wt. % (meth)acrylic acid or (meth)acrylate, particularly preferably acrylic acid acrylate, and maleic acid or maleate and 5 wt. % to 40 wt. %, preferably 10 wt. % to 30 wt. % vinyl alcohol and/or vinyl acetate. Most particularly preferred here are terpolymers in which the weight ratio of (meth)acrylic acid or (meth)acrylate to maleic acid or maleate is between 1:1 and 4:1, preferably between 2:1 and 3:1 and in particular 2:1 and 2.5:1. Both the quantities and the weight ratios are based on the acids here. The second acidic monomer or salt thereof can also be a derivative of an allylsulfonic acid, which is substituted in 2-position with an alkyl residue, preferably with a C₁-C₄ alkyl residue, or an aromatic residue which is preferably derived from benzene or benzene derivatives. Preferred terpolymers here contain 40 wt. % to 60 wt. %, in particular 45 to 55 wt. % (meth)acrylic acid or (meth)acrylate, particularly preferably acrylic acid or acrylate, 10 wt. % to 30 wt. %, preferably 15 wt. % to 25 wt. % methallyl sulfonic acid or methallyl sulfonate and, as the third monomer, 15 wt. % to 40 wt. %, preferably 20 wt. % to 40 wt. % of a carbohydrate. This carbohydrate can be e.g. a mono-, di-, oligo- or polysaccharide, with mono-, di- or oligosaccharides being preferred and sucrose being particularly preferred. Through the use of the third monomer, it is assumed that predetermined breaking points, which are responsible for the good biodegradability of the polymer, are incorporated into the polymer. These terpolymers generally have a relative molecular mass of between 1000 g/mol and 200000 g/mol, preferably between 3000 g/mol and 10000 g/mol. They can be employed, particularly for the production of liquid agents, in the form of aqueous solutions, preferably in the form of 30 to 50 wt. % aqueous solutions. All of the said polycarboxylic acids are generally employed in the form of their water-soluble salts, in particular their alkali salts.

These organic builder substances are contained preferably in quantities of up to 40 wt. %, in particular up to 25 wt. % and particularly preferably of 1 wt. % to 5 wt. %. Quantities close to the said upper limit are preferably employed in paste-like or liquid, in particular aqueous, agents.

In particular, crystalline or amorphous alkali aluminosilicates are employed as water-insoluble, water-dispersible inorganic builder materials in quantities of up to 50 wt. %, preferably no more than 40 wt. % and in liquid agents in particular from 1 wt. % to 5 wt. %. Among these, the crystalline aluminosilicates in detergent grade, in particular zeolite NaA and optionally NaX, are preferred. Quantities close to the said upper limit are preferably employed in solid, particulate agents. Suitable aluminosilicates have in particular no particles with a particle size greater than 30 mm and preferably consist of at least 80 wt. % of particles having a size below 10 mm. Their calcium-binding capacity, which can be determined according to the statements in the German patent specification DE 24 12 837, is in the range from 100 to 200 mg CaO per gram. Suitable substitutes or partial substitutes for the said aluminosilicate are crystalline alkali silicates, which can be present individually or in a mixture with amorphous silicates. The alkali silicates that can be used in the agents as builders preferably have a molar ratio of alkali oxide to SiO₂ of less than 0.95, in particular from 1:1.1 to 1:12, and can be present in amorphous or crystalline form. Preferred alkali silicates are the sodium silicates, in particular the amorphous sodium silicates, with a molar ratio of Na₂O:SiO₂ from 1:2 to 1:2.8. These amorphous alkali silicates are commercially available, e.g. with the name Portil®. They are added during the production preferably as a solid and not in the form of a solution. As crystalline silicates that can be present individually or in a mixture with amorphous silicates, preferably crystalline layered silicates of the general formula Na₂SiₓO₂ₓ₊₁.yH₂O are employed, in which x, the so-called modulus, is a number from 1.9 to 4 and y is a number from 0 to 20 and preferred values for x are 2, 3 or 4. Preferred crystalline layered silicates are those in which x in the said general formula assumes the values of 2 or 3. In particular, both β- and δ-sodium disilicates (Na₂Si₂O₅.yH₂O) are preferred. Virtually anhydrous crystalline alkali silicates of the aforesaid general formula, in which x represents a number from 1.9 to 2.1, made from amorphous alkali silicates, can also be employed in agents that contain an active agent to be used according to the invention. In a further preferred embodiment of agents according to the invention, a crystalline sodium layered silicate having a modulus of 2 to 3 is employed, as can be produced from sand and soda. Crystalline sodium silicates with a modulus in the range from 1.9 to 3.5 are employed in another preferred embodiment of washing agents that contain an active agent used according to the invention. Their content of alkali silicates is preferably 1 wt. % to 50 wt. % and in particular 5 wt. % to 35 wt. %, based on anhydrous active substance. If alkali aluminosilicate, in particular zeolite, is present as an additional builder substance, the content of alkali silicate is preferably 1 wt. % to 15 wt. % and in particular 2 wt. % to 8 wt. %, based on anhydrous active substance. The weight ratio of aluminosilicate to silicate, based in each case on anhydrous active substances, is then preferably 4:1 to 10:1. In agents that contain both amorphous and crystalline alkali silicates, the weight ratio of amorphous alkali silicate to crystalline alkali silicate is preferably 1:2 to 2:1 and in particular 1:1 to 2:1.

In addition to the said inorganic builder, further water-soluble or water-insoluble inorganic substances can be contained in the agents that contain an active agent to be used according to the invention, are used together with this or are employed in methods according to the invention. Suitable in this context are the alkali carbonates, alkali hydrogencarbonates and alkali sulfates and mixtures thereof. This additional inorganic material can be present in quantities of up to 70 wt. %.

In addition, the agents can contain further constituents that are conventional in washing and cleaning agents. These optional constituents include in particular enzymes, enzyme stabilizers, complexing agents for heavy metals, e.g. aminopolycarboxylic acids, aminohydroxypolycarboxylic acids, polyphosphonic acids and/or aminopolyphosphonic acids, foam inhibitors, e.g. organopolysiloxanes or paraffins, solvents and optical brighteners, e.g. stilbene disulfonic acid derivatives. Preferably contained in agents that contain an active agent used according to the invention are up to 1 wt. %, in particular 0.01 wt. % to 0.5 wt. % optical brighteners, in particular compounds from the class of the substituted 4,4′-bis(2,4,6-triamino-s-triazinyl)-stilbene-2,2′-disulfonic acids, up to 5 wt. %, in particular 0.1 wt. % to 2 wt. % complexing agents for heavy metals, in particular aminoalkylene phosphonic acids and salts thereof and up to 2 wt. %, in particular 0.1 wt. % to 1 wt. % foam inhibitors, said proportions by weight being based on total agent in each case.

Solvents that can be employed in liquid agents in particular are, in addition to water, preferably those that are water-miscible. These include the lower alcohols, e.g. ethanol, propanol, isopropanol and the isomeric butanols, glycerol, lower glycols, e.g. ethylene glycol and propylene glycol, and the ethers that can be derived from said classes of compounds. The active agents used according to the invention are generally present in these liquid agents in dissolved or suspended form.

Optionally present enzymes are preferably selected from the group comprising protease, amylase, lipase, cellulase, hemicellulase, oxidase, peroxidase or mixtures of these. Protease obtained from microorganisms, such as bacteria or fungi, is primarily suitable. It can be obtained from suitable microorganisms in a known manner by fermentation processes. Proteases are commercially available e.g. with the names BLAP®, Savinase®, Esperase®, Maxatase®, Optimase®, Alcalase®, Durazym® or Maxapem®. The lipase that can be employed can be obtained e.g. from Humicola lanuginosa, from Bacillus species, from Pseudomonas species, from Fusarium species, from Rhizopus species or from Aspergillus species. Suitable lipases are commercially available e.g. with the names Lipolase®, Lipozym®, Lipomax®, Lipex®, Amano®-Lipase, Toyo-Jozo®-Lipase, Meito®-Lipase and Diosynth®-Lipase. Suitable amylases are commercially available e.g. with the names Maxamyl®, Termamyl®, Duramyl® and Purafect® OxAm. The cellulase that can be employed can be an enzyme that is obtainable from bacteria or fungi, which has a pH optimum preferably in the weakly acidic to weakly alkaline range from 6 to 9.5. These cellulases are commercially available with the names Celluzyme®, Carezyme® and Ecostone®.

The conventional enzyme stabilizers that are optionally present, in particular in liquid agents, include amino alcohols, e.g. mono-, di- and triethanol- and -propanolamine and mixtures thereof, lower carboxylic acids, boric acid or alkali borates, boric acid-carboxylic acid combinations, boronic acid esters, boric acid derivatives, calcium salts, e.g. Ca-formic acid combination, magnesium salts and/or sulfur-containing reducing agents.

The suitable foam inhibitors include long-chain soaps, in particular behenic soap, fatty acid amides, paraffins, waxes, microcrystalline waxes, organopolysiloxanes and mixtures thereof, which can additionally contain microfine, optionally silanized or otherwise hydrophobically modified silica. For use in particulate agents, these foam inhibitors are preferably bound to granular, water-soluble carrier substances.

In a preferred embodiment, an agent into which active agent to be used according to the invention is incorporated is particulate and contains up to 25 wt. %, in particular 5 wt. % to 20 wt. % bleaching agent, in particular alkali percarbonate, up to 15 wt. %, in particular 1 wt. % to 10 wt. % bleach activator, 20 wt. % to 55 wt. % inorganic builder, up to 10 wt. %, in particular 2 wt. % to 8 wt. % water-soluble organic builder, 10 wt. % to 25 wt. % synthetic anionic surfactant, 1 wt. % to 5 wt. % nonionic surfactant and up to 25 wt. %, in particular 0.1 wt. % to 25 wt. % inorganic salts, in particular alkali carbonate and/or alkali hydrogencarbonate.

In another preferred embodiment, an agent into which active agent to be used according to the invention is incorporated is liquid and contains 1 wt. % to 25 wt. %, in particular 5 wt. % to 15 wt. % nonionic surfactant, up to 10 wt. %, in particular 0.5 wt. % to 8 wt. % synthetic anionic surfactant, 3 wt. % to 15 wt. %, in particular 5 wt. % to 10 wt. % soap, 0.5 wt. % to 5 wt. %, in particular 1 wt. % to 4 wt. % organic builder, in particular polycarboxylate, such as citrate, up to 1.5 wt. %, in particular 0.1 wt. % to 1 wt. % complexing agent for heavy metals, such as phosphonate, and in addition to optionally contained enzyme, enzyme stabilizer, dye and/or scent, water and/or water-miscible solvent.

The use of a combination of a soil release promoting active agent that is essential to the invention with a soil release promoting polymer comprising a dicarboxylic acid and an optionally polymeric diol to enhance the cleaning performance of washing agents in the washing of textiles is also possible. In the context of agents according to the invention and of the method according to the invention, those combinations with, in particular, a polyester-active soil release promoting polymer are also possible.

The known polyester-active soil release promoting polymers that can be employed in addition to the active agents that are essential to the invention include copolyesters of dicarboxylic acids, e.g. adipic acid, phthalic acid or terephthalic acid, diols, e.g. ethylene glycol or propylene glycol, and polydiols, e.g. polyethylene glycol or polypropylene glycol. The soil release promoting polyesters that are preferably employed include those compounds that are formally obtainable by esterification of two monomer parts, wherein the first monomer is a dicarboxylic acid HOOC-Ph-COOH and the second monomer is a diol HO—(CHR¹¹—)ₐOH, which can also be present as a polymeric diol H—(O—(CHR¹¹—)ₐ)_{b}OH. Ph here signifies an o-, m- or p-phenylene residue, which can carry 1 to 4 substituents selected from alkyl residues with 1 to 22 C atoms, sulfonic acid groups, carboxyl groups and mixtures thereof, R¹¹ signifies hydrogen, an alkyl residue with 1 to 22 C atoms and mixtures thereof, and a signifies a number from 2 to 6 and b a number from 1 to 300. Preferably present in the polyesters that are obtainable therefrom are both monomeric diol units —O—(CHR¹¹—)ₐO— and polymeric diol units —(O—(CHR¹¹—)ₐ)_{b}O—. The molar ratio of monomeric diol units to polymeric diol units is preferably 100:1 to 1:100, in particular 10:1 to 1:10. In the polymeric diol units, the degree of polymerization b is preferably in the range from 4 to 200, in particular from 12 to 140. The molecular weight or average molecular weight or the maximum of the molecular weight distribution of preferred soil release promoting polyesters is in the range from 250 g/mol to 100 000 g/mol, in particular from 500 g/mol to 50 000 g/mol. The acid on which the Ph residue is based is preferably selected from terephthalic acid, isophthalic acid, phthalic acid, trimellitic acid, mellitic acid, the isomers of sulfophthalic acid, sulfoisophthalic acid and sulfoterephthalic acid and mixtures thereof. Insofar as the acid groups thereof are not part of the ester bonds in the polymer, they are preferably present in the form of a salt, in particular as an alkali or ammonium salt. Among these, the sodium and potassium salts are particularly preferred. If desired, instead of the monomer HOOC-Ph-COOH, small proportions, in particular no more than 10 mole %, based on the proportion of Ph with the meaning given above, of other acids having at least two carboxyl groups can be contained in the soil release promoting polyester. These include e.g. alkylene and alkenylene dicarboxylic acids, such as malonic acid, succinic acid, fumaric acid, maleic acid, glutaric acid, adipic acid, pimelic acid, suberic acid, azelaic acid and sebacic acid. The preferred diols HO—(CHR¹¹—)ₐOH include those in which R¹¹ is hydrogen and a is a number from 2 to 6, and those in which a assumes the value 2 and R¹¹ is selected from among hydrogen and the alkyl residues with 1 to 10, in particular 1 to 3 C atoms. Among the last-mentioned diols, those of the formula HO—CH₂—CHR¹¹—OH, in which R¹¹ has the aforesaid meaning, are particularly preferred. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Particularly preferred among the polymeric diols is polyethylene glycol with an average molar mass in the range from 1000 g/mol to 6000 g/mol.

If desired, these polyesters with the composition described above can also be end-capped, in which case alkyl groups with 1 to 22 C atoms and esters of monocarboxylic acids are suitable as end groups. The end groups bound via ester bonds can be based on alkyl, alkenyl and aryl monocarboxylic acids with 5 to 32 C atoms, in particular 5 to 18 C atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachic acid, gadoleic acid, arachidonic acid, behenic acid, erucic acid, brassidic acid, clupanodonic acid, lignoceric acid, cerotic acid, melissic acid, benzoic acid, which can carry 1 to 5 substituents with a total of up to 25 C atoms, in particular 1 to 12 C atoms, e.g. tert.-butylbenzoic acid. The end groups can also be based on hydroxymonocarboxylic acids with 5 to 22 C atoms, which include e.g. hydroxyvaleric acid, hydroxycaproic acid, ricinoleic acid, the hydrogenation product thereof hydroxystearic acid and o-, m- and p hydroxybenzoic acid. The hydroxymonocarboxylic acids can in turn be bound together via their hydroxyl group and their carboxyl group and thus can be present multiple times in an end group. The number of hydroxymonocarboxylic acid units per end group, i.e. their degree of oligomerization, is preferably in the range from 1 to 50, in particular from 1 to 10. In a preferred embodiment of the invention, polymers comprising ethylene terephthalate and polyethylene oxide terephthalate, in which the polyethylene glycol units have molecular weights of 750 to 5000 and the molar ratio of ethylene terephthalate to polyethylene oxide terephthalate is 50:50 to 90:10, are used in combination with an active agent that is essential to the invention.

The polyester-active soil release promoting polymers are preferably water-soluble, the term “water-soluble” being understood to mean a solubility of at least 0.01 g, preferably at least 0.1 g of the polymer per liter of water at room temperature and pH 8. However, preferably employed polymers have a solubility under these conditions of at least 1 g per liter, in particular at least 10 g per liter.

Preferred laundry post-treatment agents that contain an active agent to be used according to the invention comprise as a fabric-softening active agent a so-called esterquat, i.e. a quaternized ester of carboxylic acid and amino alcohol. These are known substances, which can be obtained by the relevant methods of preparative organic chemistry, e.g. by partially esterifying triethanolamine in the presence of hypophosphorous acid with fatty acids, passing through air and then quaternizing with dimethyl sulfate or ethylene oxide. The production of solid esterquats is also known, in which the quaternizing of triethanolamine esters is carried out in the presence of suitable dispersing agents, preferably fatty alcohols.

Preferred esterquats in the agents are quaternized fatty acid triethanolamine ester salts that follow formula (IV),

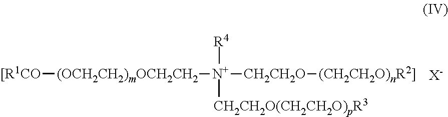

in which R¹CO denotes an acyl residue with 6 to 22 carbon atoms, R² and R³ independently of one another denote hydrogen or R¹CO, R⁴ denotes an alkyl residue with 1 to 4 carbon atoms or a (CH₂CH₂O)_{q}H group, m, n and p in total denote 0 or numbers from 1 to 12, q denotes numbers from 1 to 12 and X denotes a charge-compensating anion, such as halide, alkyl sulfate or alkyl phosphate. Typical examples of esterquats that can be used within the meaning of the invention are products based on caproic acid, caprylic acid, capric acid, lauric acid, myristic acid, palmitic acid, isostearic acid, stearic acid, oleic acid, elaidic acid, arachic acid, behenic acid and erucic acid and technical mixtures thereof, as obtained e.g. from the cleaving of natural fats and oils under pressure. Technical C_{12/18} coconut fatty acids and in particular partially hydrogenated C_{16/18} tallow or palm fatty acids and elaidic acid-rich C_{16/18} fatty acid blends are preferably employed. To produce the quaternized esters, the fatty acids and triethanolamine can generally be employed in a molar ratio from 1.1:1 to 3:1. With regard to the application properties of the esterquats, a use ratio from 1.2:1 to 2.2:1, preferably 1.5:1 to 1.9:1, has proved particularly advantageous. The preferably employed esterquats represent technical mixtures of mono-, di- and triesters with an average degree of esterification of 1.5 to 1.9 and are derived from technical C_{16/18} tallow or palm fatty acid (iodine value 0 to 40). Quaternized fatty acid triethanolamine ester salts of formula (IV), in which R¹CO denotes an acyl residue with 16 to 18 carbon atoms, R² denotes R¹CO, R³ denotes hydrogen, R⁴ denotes a methyl group, m, n and p denote 0 and X denotes methyl sulfate have proved particularly advantageous.

In addition to the quaternized carboxylic acid triethanolamine ester salts, other suitable esterquats are quaternized ester salts of carboxylic acids with diethanol alkylamines of formula (V),

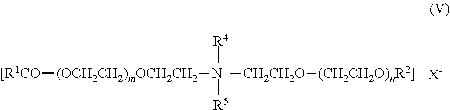

in which R¹CO denotes an acyl residue with 6 to 22 carbon atoms, R² denotes hydrogen or R¹CO, R⁴ and R⁵ independently of one another denote alkyl residues with 1 to 4 carbon atoms, m and n in total denote 0 or numbers from 1 to 12 and X denotes a charge-compensating anion, such as halide, alkyl sulfate or alkyl phosphate.

Finally, a further group of suitable esterquats that should be mentioned are the quaternized ester salts of carboxylic acids with 1,2-dihydroxypropyldialkylamines of formula (VI),

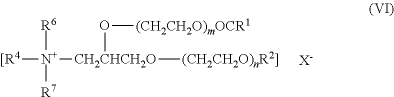

in which R¹CO denotes an acyl residue with 6 to 22 carbon atoms, R² denotes hydrogen or R¹CO, R⁴, R⁶ and R⁷ independently of one another denote alkyl residues with 1 to 4 carbon atoms, m and n in total denote 0 or numbers from 1 to 12 and X denotes a charge-compensating anion, such as halide, alkyl sulfate or alkyl phosphate.

With regard to the selection of the preferred fatty acids and of the optimum degree of esterification, the statements made for (IV) by way of example also apply mutatis mutandis to the esterquats of formulae (V) and (VI). The esterquats are usually marketed in the form of 50 to 90 weight per cent alcoholic solutions, which can also be diluted with water without any problems, with ethanol, propanol and isopropanol being the usual alcoholic solvents.

Esterquats are preferably used in quantities of 5 wt. % to 25 wt. %, in particular 8 wt. % to 20 wt. %, based in each case on total laundry post-treatment agent. If desired, the laundry post-treatment agents used according to the invention can additionally contain the above-mentioned washing agent ingredients, insofar as they have no unacceptably negative interaction with the esterquat. The agent is preferably a liquid, aqueous agent.

### EXAMPLES

A washing agent composition V containing

| | |
|---|---|
| fatty alcohol polyethylene oxide | 7.0 wt. % |
| fatty acid from coconut oil | 9.4 wt. % |
| boric acid | 3.7 wt. % |
| citric acid | 2.1 wt. % |
| propylene glycol | 6.0 wt. % |
| Na-diethylenetriamine | 0.2 wt. % |
| pentamethylene phosphonate | |
| NaOH | 3.1 wt. % |
| protease | 0.7 wt. % |
| amylase | 0.1 wt. % |
| water | balance to 100 wt. % |

and a washing agent composition M of otherwise identical composition, which contained 0.059 wt. % microfibrillar cellulose with a reduced proportion of water, were used. Clean textiles made of cotton were washed under the following conditions:
washing machine: Miele W 918 Novotronic®
wash program: single-wash method, standard program
washing temperature: 40° C.
liquor volume: 17 I
water hardness: 16° dH
ballast laundry: 3.5 kg clean laundry incl. test textiles (pillow cases, tricot, dish towels, huckaback towels)
   with 75 g of one of the aforesaid washing agent compositions in each case. After the third wash cycle, the textiles were soiled with engine oil. The intensity of the soil was recorded using a Minolta CR 200 camera, and then the soiled test textiles were left to stand for 7 days at room temperature. They were then washed again under the above conditions, and then allowed to dry and the intensity values of the soils were again determined using the Minolta CR 200 camera.

The following table gives the differences between the intensity values (Y) obtained before and after washing the soiled textiles. The higher the value, the more intense the brightening achieved by the active agent according to the invention. The results are average values from 5 wash tests carried out in parallel in each case.

TABLE 1
Wash results

| Agent | Difference in intensity |
|---|---|
| V | 39 |
| M | 50 |

The results show that, by adding the microfibrillar cellulose to the washing agent composition, an increase in the grease-dissolving power was achieved with regard to engine oil.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method of enhancing the cleaning performance of washing agents during the washing of textiles, comprising: washing a hard surface or textile with a cleaning agent including microfibrillar cellulose.

2. The method of claim 1, wherein the microfibrillar cellulose forms a protective layer on the hard surface or textile fabrics.

3. The method of claim 1, wherein the microfibrillar cellulose has a diameter of 20 nm to 600 nm.

4. The method of claim 1, wherein the microfibrillar cellulose has a diameter of 100 nm to 200 nm.

5. The method of claim 1, wherein the microfibrillar cellulose has a number average length of 50 μm to 500 μm.

6. The method of claim 1, wherein the microfibrillar cellulose has a number average length of 80 μm to 200 μm.

7. The method of claim 1, wherein the microfibrillar cellulose has a length of 1 μm to 20 μm.

8. The method of claim 1, wherein the microfibrillar cellulose has a length of 3 μm to 5 μm.

9. A method of washing textiles or cleaning hard surfaces, comprising:
in the presence of a liquor, contacting the textiles or hard surfaces with a cleaning agent comprising a microfibrillar cellulose.

10. The method according to claim 9, wherein the microfibrillar cellulose is present in the cleaning agent at a concentration of in that the concentration 0.05 wt. % to 3 wt. %.

11. The method of claim 9, wherein the microfibrillar cellulose is present in the cleaning agent at a concentration of in that the concentration 0.2 wt. % to 1 wt. %.

12. A washing or cleaning agent containing microfibrillar cellulose.

13. The washing or cleaning agent according to claim 12, wherein the washing or cleaning agent comprises 0.01 wt. % to 10 wt. % microfibrillar cellulose.

14. The washing or cleaning agent according to claim 12, wherein the washing or cleaning agent comprises 0.05 wt. % to 4 wt. % microfibrillar cellulose.

15. A laundry post-treatment agent, in particular a softener, containing microfibrillar cellulose.

16. The laundry post-treatment agent according to claim 15, wherein the washing or cleaning agent comprises 0.01 wt. % to 10 wt. % microfibrillar cellulose.

17. The laundry post-treatment agent according to claim 15, wherein the washing or cleaning agent comprises 0.05 wt. % to 4 wt. % microfibrillar cellulose.
